(19) United States
(12) Patent Application Publication
(10) Pub. No.: US 2010/0246415 A1
(43) Pub. Date: Sep. 30, 2010

(54) NETWORK TESTING METHOD AND SYSTEM

(75) Inventors: Tetsuya Nishi, Kawasaki (JP); Tomonori Gotoh, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/782,907

(22) Filed: May 19, 2010

Related U.S. Application Data
(63) Continuation of application No. PCT/JP2007/072566, filed on Nov. 21, 2007.

(51) Int. Cl. H04L 12/26

(52) U.S. Cl. 370/248

(57) ABSTRACT

In order to preliminarily perform a load test or the like of an IP network, a test apparatus instructs a test packet transmitting device to transmit a test packet having a specified multicast address and instructs a test packet receiving device to receive the test packet of the multicast address. The test apparatus further instructs a first relay device to relay the test packet of the multicast address and instructs a second relay device to perform a route optimization excluding processing. The test packet receiving device requests the second relay device to transfer the test packet of the multicast address when the test packet receiving device has received the instruction to receive the test packet.

### CROSS-REFERENCE TO RELATED APPLICATION

This application is a continuation of International Application PCT/JP2007/72566 filed on Nov. 21, 2007, the contents of which are herein wholly incorporated by reference.

### FIELD

The present invention relates to a network testing method and system for preliminarily performing a load test of an IP network.

### BACKGROUND

As depicted in FIG. 14, in an IP network where a server SV and a customer LAN (Local Area Network) 11-LAN 13 are connected over a relay network RN, for adding a new service such as VoIP, it is important to preliminarily perform a communication/quality confirmation between multipoints and a high load test for estimating a call-enabled connection number or the like, thereby performing a verification of a network quality such as an identification of a faulted point (bottleneck BN) within the network, an investigation of a call connection number causing a quality deterioration to get started or the like.

In order to perform a quality test between multipoints, as depicted in FIG. 14, load test measuring instruments 100 which can transmit/receive a packet between subnets by designating various source and destination IP addresses are employed for a related art testing method or system.

It is to be noted that there has been proposed a network quality evaluation apparatus capable of performing low-cost and high-reliability network quality evaluation, in which probes are installed on a network to be measured, and a first probe includes a test packet generating means for generating a test packet including, in a payload, a sequence number indicating a packet generation order in one probe and an extraction means for extracting required data from a predetermined packet being passed and for writing the extracted data into a memory; a second probe includes a test packet response means for writing reception time information, processing time information and a sequence number indicating a packet generation order in the second probe into a payload of a test packet when the test packet outputted from the first probe is received, and redirecting the test packet to the first probe; based on the data extracted and written in the memory by the first probe, communication quality of the network to connect these terminals is evaluated (See e.g. Japanese Laid-open Patent Publication No. 2007-49602).

The related art testing method or system is disadvantageous in that in order to perform quality tests over a plurality of subnets at the same time, expensive measuring instruments are respectively required to be arranged in the subnets with a very high cost.

### SUMMARY

According to an aspect of a network testing method (or system) in the invention, a test apparatus or a test packet transmitting device instructs a test packet receiving device to receive a test packet having a specified multicast address, instructs a first relay device to relay the test packet having the multicast address and instructs a second relay device to perform a route optimization excluding processing; in which the test packet receiving device requests the second relay device to transfer the test packet having the multicast address when the test packet receiving device has received the instruction to receive the test packet.

The above second relay device may include a route controller measuring a reception bandwidth of the test packet of the multicast address when receiving a set condition of a reception bandwidth for the instruction to perform the route optimization excluding processing and enabling the route optimization excluding processing to be performed when the reception bandwidth measured satisfies the set condition.

It is to be noted that when a test start time is additionally set for the instruction to perform the route optimization excluding processing, the route controller executes the route optimization excluding processing when the test start time set has come.

The above second relay device may have a route controller enabling the route optimization excluding processing to be performed if an address of the packet received is found to be the multicast address when the multicast address for the instruction to perform the route optimization excluding processing is received.

Furthermore, the above test packet transmitting device may include a plurality of test packet transmitting devices, in which the test packet transmitting device or the test packet receiving device can notify the multicast address to the test apparatus before the start of test.

The object and advantages of the embodiment will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a schematic diagram depicting a network arrangement used in a network testing method and system;

FIG. 2 is a schematic diagram more specifically depicting the network arrangement in FIG. 1;

FIG. 3 is a sequence diagram depicting an overall operation of an embodiment [1] of a network testing method and system;

FIG. 4 is a format diagram of an IP packet;

FIG. 5 is a diagram illustrating an operation example of PIM-SM (Protocol Independent Multicast-Sparse Mode) known in a related art;

FIGS. 6A-6D are diagrams illustrating a route optimization process in PIM-SM;

FIG. 7 is a flow chart depicting an operation example (1) of a route controller;

FIG. 8 is a flow chart depicting an operation example (2) of a route controller;

FIG. 9 is a flow chart depicting an operation example (3) of a route controller;

FIG. 10 is a schematic diagram depicting an embodiment [2] of a network testing method and system;

FIG. 11 is a schematic diagram more specifically depicting the network arrangement in FIG. 10;

FIG. 12 is a schematic block diagram depicting an applied example (No. 1);

FIG. 13 is a schematic block diagram depicting an applied example (No. 2); and

FIG. 14 is a diagram depicting a network arrangement for describing a related art.

### DESCRIPTION OF EMBODIMENTS

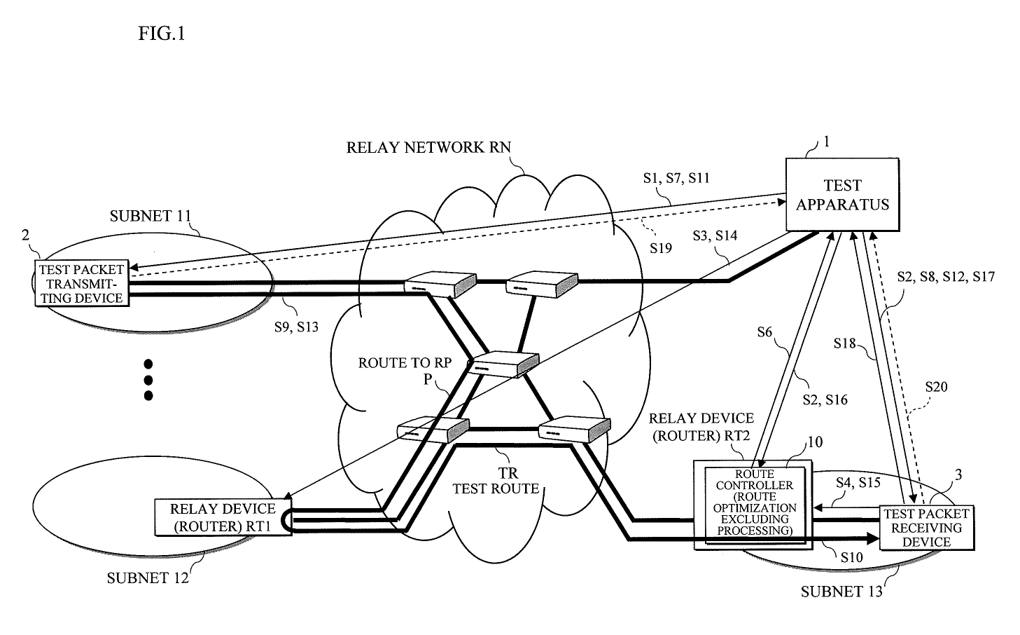

### Embodiment [1]: FIGS. 1-9

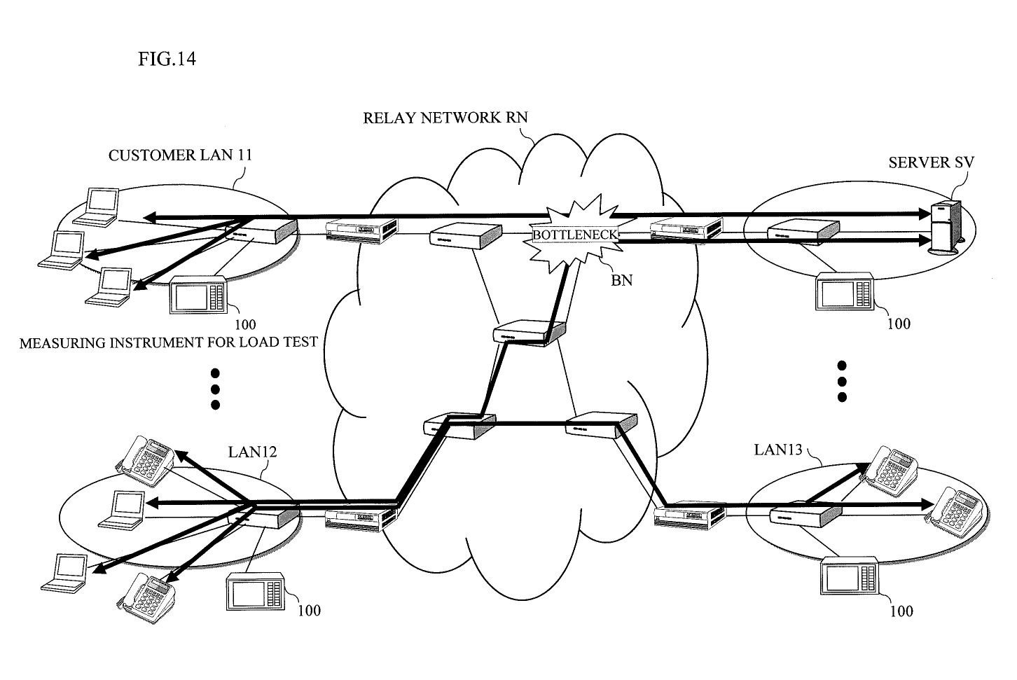

FIG. 1 depicts a network for schematically illustrating a network testing method and system according to the present invention, composed of subnets 11-13 in the same manner as the network depicted in FIG. 14 and a test apparatus 1 such as a server connected to the subnets 11-13 through a relay network RN, where the test apparatus 1 may be provided within a specific subnet (not depicted) or within any one of the subnets 11-13.

Also in this embodiment, a test packet transmitting device 2 is provided in the subnet 11, a relay device (first relay device or router) RT1 is provided in the subnet 12 and a relay device (second relay device or router) RT2 and a test packet receiving device 3 are provided in the subnet 13. Furthermore, the relay device RT2 includes a route controller 10 as will be described later. It is to be noted that the above test apparatus 1 may be replaced by the test packet receiving device 2 as far as the device 2 has the same function.

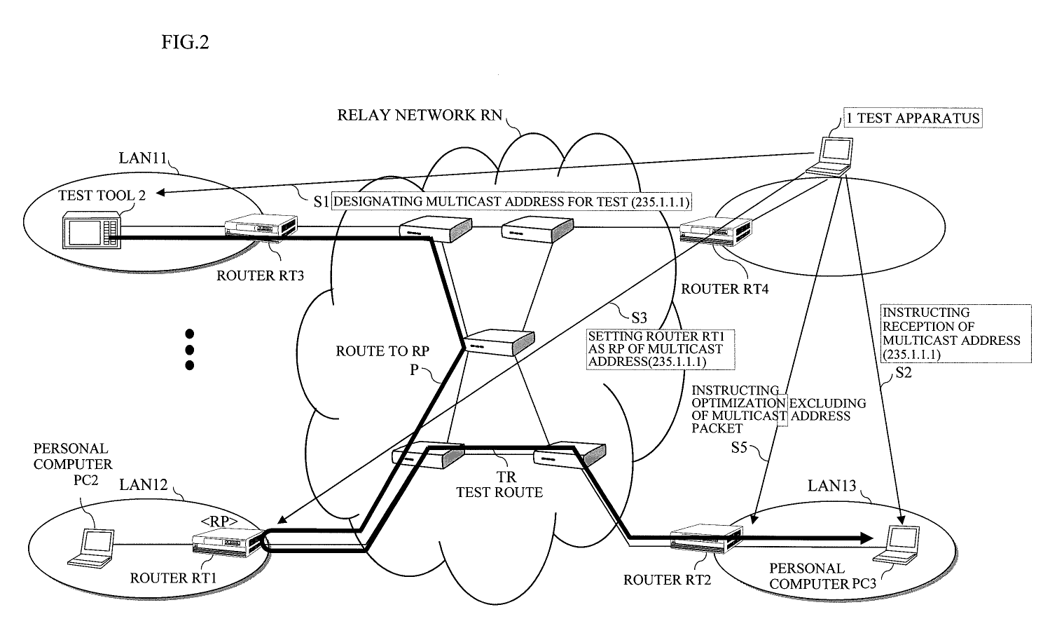

A more specific example of the network depicted in FIG. 1 is further depicted in FIG. 2, in which each of the subnets 11-13 is formed of an LAN (Local Area Network), a test tool 2 in the LAN 11 corresponds to the test packet transmitting device 2 in the subnet 11, the relay device RT1 in the LAN 12 corresponds to the router RT1 in the subnet 12 and the router RT2 in the LAN 13 corresponds to the relay device RT2 in the subnet 13.

Also, the test tool 2 in the LAN 11 is connected to the relay network RN through a router RT3, the router RT1 in the LAN 12 is connected to a personal computer PC2 and a personal computer PC3 in the LAN 13 corresponds to the test packet receiving device 3 in the subnet 13. The test apparatus 1 is connected to the relay network RN through a router RT4.

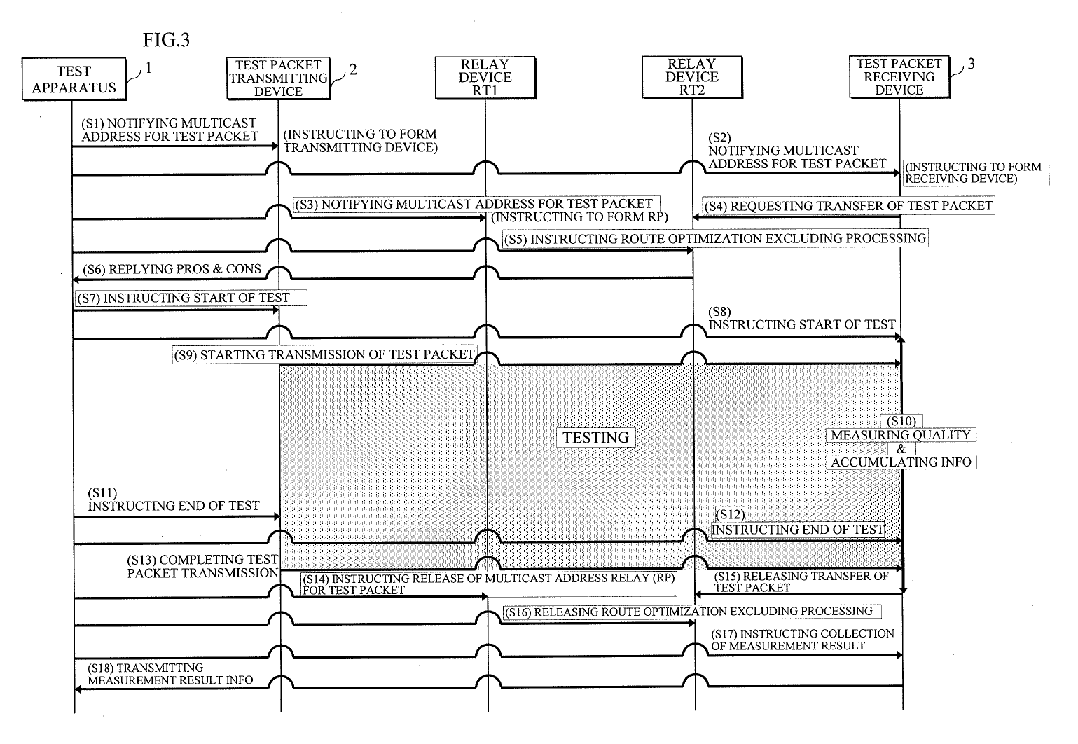

A testing method and system for the network depicted in FIGS. 1 and 2 will now be described mainly referring to the network depicted in FIG. 1 along a sequence depicted in FIG. 3.
Step S1: First, the test apparatus 1 notifies a multicast address for a test packet to the test packet transmitting device 2, whereby the test packet transmitting device 2 is to be instructed to form a transmitting device of the test packet.

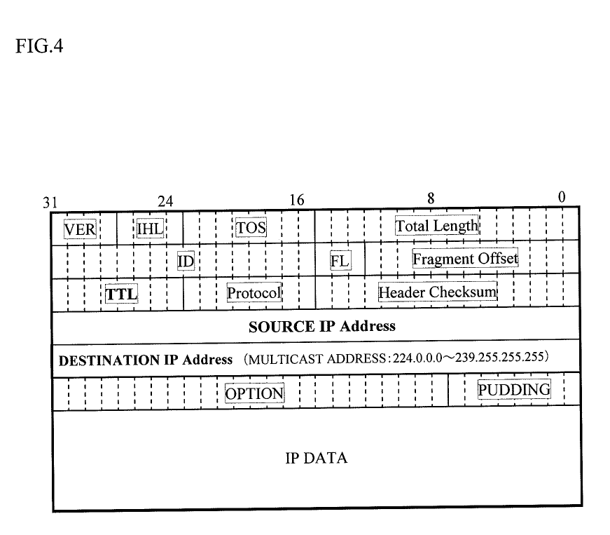

A format of an IP packet for thus notifying a multicast address is depicted in FIG. 4, in which the test apparatus 1 writes any one of addresses “224.0.0.0-239.255.255.255” in a field of IP data as a destination address for test to be notified to the test packet transmitting device 1. The test packet transmitting device 2 assigns the multicast address written in the IP data field to a destination IP address field of the test packet, so that the test packet is to be transmitted/received with a specified multicast address. For this multicast address, “235.1.1.1” is used in the example of FIG. 2.
Step S2: The test apparatus 1 similarly notifies the multicast address for the test packet also to the test packet receiving device 3, whereby the test packet receiving device 3 recognizes that the device 3 itself forms a receiving device. The multicast address in this case is also “235.1.1.1” as depicted in the example of FIG. 2.

It is to be noted that the multicast address notified at the above steps S1 and S2 may be preset in the test apparatus 1, or may be provided from test packet transmitting device 2 or the test packet receiving device 3 to the test packet receiving device 3 as depicted by dotted lines in FIG. 1 (step S19 or S20).
Step S3: The test apparatus 1 similarly notifies the testing multicast address to the relay device RT1. Namely, as depicted in FIG. 2 in this case as well, the multicast address “235.1.1.1” is set to the router RT1. At this time, the IP data field of the IP packet depicted in FIG. 4 is set to indicate that the relay device RT1 forms an RP (Rendezvous Point) in the known PIM-SM (Protocol Independent Multicast-Sparse Mode).

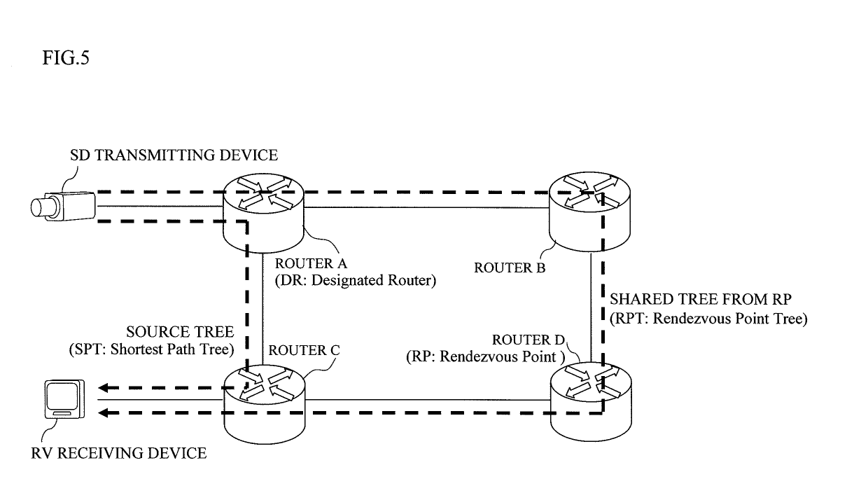

Namely, as depicted in FIG. 5, according to the PIM-SM, the routers A and B are preliminarily informed that a router D forms an RP router, in which when a transmitting device SD transmits a multicast address packet, the routers A and B pass therethrough the packet to the router D. Since the router D is preliminarily informed of a router as an object for the multicast address, the router D properly copies the packet to be transferred to the router. Therefore, the packet from the transmitting device SD is to be sent to a receiving device RV as a destination through the routers A-B-D-C in a shared RPT (Rendezvous Point Tree).

Since a route between the routers A-C is subsequently found to be the Shortest Pass Tree (SPT), the Shortest Pass Tree SPT is formed (optimization of route) and the multicast packet to the receiving device RV is to be transferred through a direct route of A→C, where this route optimization processing is not performed during the test as will be described later. By this route optimization excluding (omitting) processing, the router D is to be set at a terminal point on the transmitting side of a route (subnet) for which the router D desires to perform a quality measurement at all times during the test as the relay device RT1, so that the test packet from the test packet transmitting device 2 is to be sent to the relay device RT1 through a route P.
Step S4: By the above noted step S2, the test packet receiving device 3 having received the notification of the testing multicast address makes a transfer request of the test packet to the relay device RT2 having transferred the notification, whereby the test packet having been transferred to the relay device RT2 is necessarily transmitted to the test packet receiving device 3, and therefore the router C depicted in FIG. 5 is to be set at a terminal point on the receiving side in a route of the test packet as the relay device RT2.
Step S5: The test apparatus 1 instructs the relay device RT2 to perform the route optimization excluding processing. This enables a test measurement of a route between the relay devices RT1-RT2 by the above steps S3 and S4 to be made, which is for avoiding the following malfunction in case of adopting the above PIM-SM.

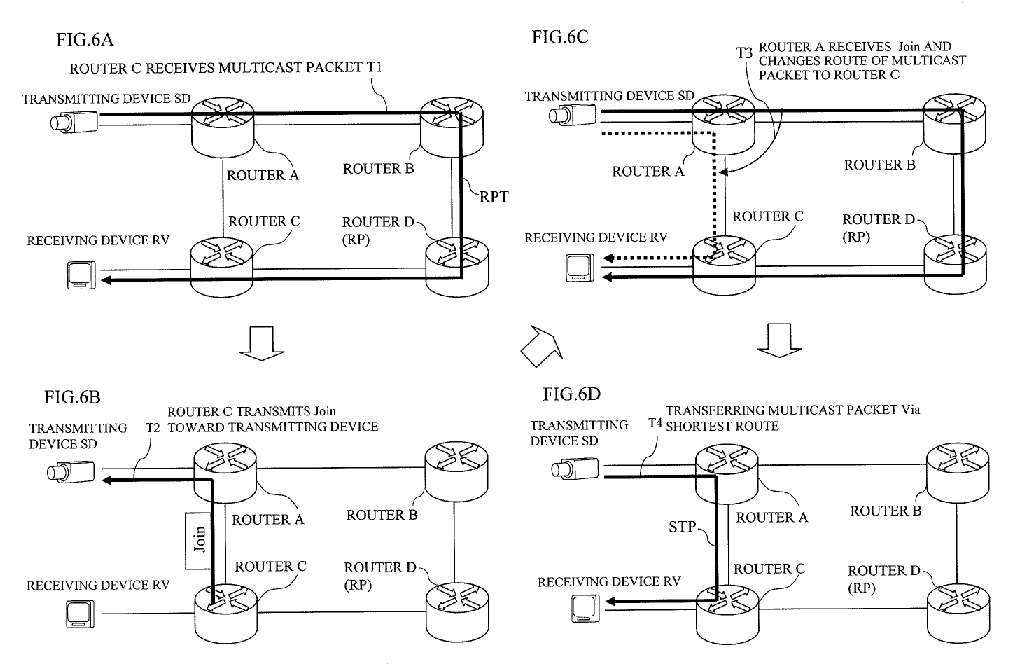

Namely, as depicted in an operation example of the PIM-SM in FIGS. 6A-6D, the router C receives the multicast packet by the shared RPT as depicted in FIG. 6A (step T1), and then transmits a Join toward the transmitting device SD (step T2 in FIG. 6B), whereby as depicted in FIG. 6C, the router A receives the Join and changes the route of the multicast packet from the transmitting device SD toward the router C (step T3), so that as depicted in FIG. 6D the multicast packet from the transmitting device SD is transferred to the receiving device RV through the shortest pass tree SPT (step T4), so that even though the route test between the routers D-C depicted in FIG. 6A is tried, the route has been already changed to the shortest pass tree SPT as depicted in FIG. 6D (optimization of route), so that the route measurement between the routers D-C can not be disadvantageously performed.

In order to avoid this, the test apparatus 1 instructs the relay device RT2 to perform the route optimization excluding processing, whereby the route optimization as depicted in FIG. 6D is not performed, so that the test packet is to necessarily pass through the route (test route TR) from the router D to the router C, enabling the quality/load test of the route from the router D to the router C to be made.

It is to be noted that if the test packet transmitting device 2 is preliminarily informed of the testing multicast address, the above steps S2, S3 and S5 may be executed by the test packet transmitting device 2 instead of the test apparatus 1.
Step S6: The relay device RT2 having received the instructions of the route optimization excluding processing at step S5 replies pros & cons thereof, i.e. an answer concerning whether or not the route optimization excluding processing has been executed, to the test apparatus 1.

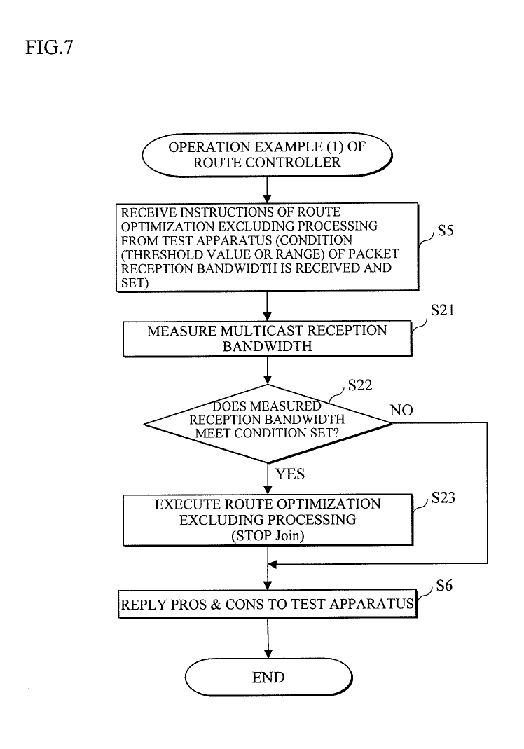

Operation examples 1-3 of the route controller 10 in the relay device RT2 from the route optimization excluding processing at the above noted-step S5 to the reply of pros & cons are respectively depicted in FIGS. 7-9, each of which will be described in the following:

### Operation Example (1) of Route Controller: FIG. 7

While at step S5 the route controller 10 receives the instructions of the route optimization excluding processing from the test apparatus 1 as mentioned above, the instructions include a condition (threshold value or its range) of the reception bandwidth of a multicast packet, so that the condition of the reception bandwidth is set inside the route controller 10.

Subsequently, the route controller 10 measures the reception bandwidth of the multicast packet (step S21) to determine whether or not the measured reception bandwidth satisfies the above set condition (step S22), where it is determined whether the reception bandwidth of the multicast packet is, for example, over or below a designated bandwidth or within a range of the designated bandwidth.

Consequently, if the measured reception bandwidth satisfies the set condition, the route controller 10 executes the route optimization excluding processing as noted above (step S23), that is halts the issuance of the Join.

The route controller 10 then replies the route optimization excluding processing having been thus executed to the test apparatus 1 (step S6), where if the measured reception bandwidth fails to satisfy the set condition, the route controller 10 notifies the test apparatus 1 of the fact, whereby the test apparatus 1 halts the subsequent operations.

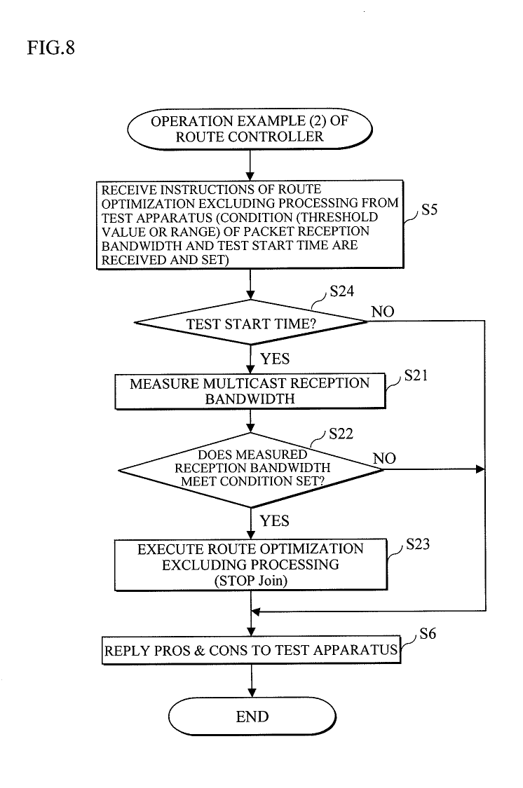

### Operation Example (2) of Route Controller: FIG. 8

In case of this operation example, in addition to the reception bandwidth in the above operation example (1) a start time of test is included in the instructions of the route optimization excluding operation (step S5).

Consequently, only when the test start time has come as indicated at step S24, steps S21-S23 also indicated in the above operation example (1) will be executed.

This enables more precise and purer quality/load tests to be performed by executing the route optimization excluding processing in a time band without working multicast traffic flow.

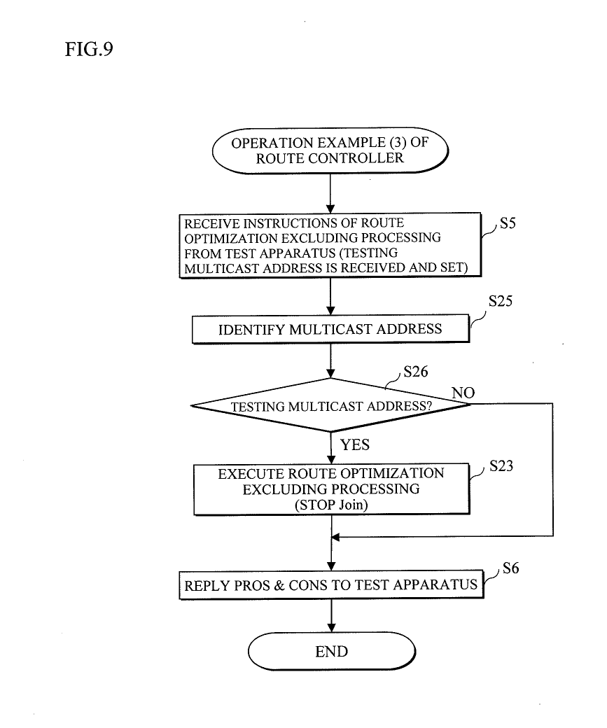

### Operation Example (3) of Route Controller: FIG. 9

In case of this operation example, by focusing on the multicast address being not notified to the relay device RT2 as noted above, in the instructions of the route optimization excluding processing at step S5, the multicast address (step S1 etc.) used for the test packet is notified to set the testing multicast address in advance and the multicast address of the received packet is identified (step S25). Only when the multicast address is the testing multicast address (step S26), the route optimization excluding processing is executed (step S23) and the response is notified to the test apparatus 1 (step S26).

This enables the quality/load test of the test route TR to be performed since the optimization of the test route TR between the relay devices RT1-RT2 only as to the test packet is not performed.
Step S7: When the response from the relay device RT2 at step S6 indicates that the route optimization excluding processing has been done, the test apparatus 1 instructs the test packet transmitting device 2 to start the test.
Step S8: The test apparatus 1 also instructs the test packet receiving device 3 to start the test.
Step S9: The test packet transmitting device 2 starts the transmission of the test packet having stored therein the testing multicast address notified at step S1.
Step S10: The test packet receiving device 3 receives and confirms that the address in the test-multicast packet through the relay devices RT1-RT2 transmitted from the test packet transmitting device 2 is consistent with the testing multicast address set at step S2, thereby measuring the quality (loss, delay, fluctuation etc.) and accumulates the information. By receiving the multicast test packet corresponding to a connection number or a bandwidth necessary for services to be newly added, the quality/load test between the relay devices RT1-RT2 can be made.
Step S11: The test apparatus 1 instructs the test packet transmitting device 2 to end the test.
Step S12: The test apparatus 1 similarly instructs the test packet receiving device 3 to end the test.
Step S13: The test packet transmitting device 2 ends the transmission of the above test packet in response to the instructions of the test end by step S11.
Step S14: The test apparatus 1 instructs the relay device RT1 to release the relay operation of the multicast address for test packet. This prevents the testing multicast address from being relayed even though it is erroneously transmitted after the end of test.
Step S15: In response to the instructions of test end from the test apparatus 1 by step S12, the test packet receiving device 3 requests the relay device RT2 to release the transfer of the test packet. This prevents the relay device RT2 from transmitting the test packet to the test packet receiving device 3.
Step S16: The test apparatus 1 instructs the relay device RT2 to release the route optimization excluding processing. This enables the relay device RT2 to restore the original function of the PIM-SM as depicted in FIG. 6 and to recover the route optimization processing.
Step S17: The test apparatus 1 instructs the test packet receiving device 3 to collect the measurement results.
Step S18: According to the instructions at step S17, the test packet receiving device 3 transmits the measurement results of the quality/load of the route measured at step S10 to the test apparatus 1.

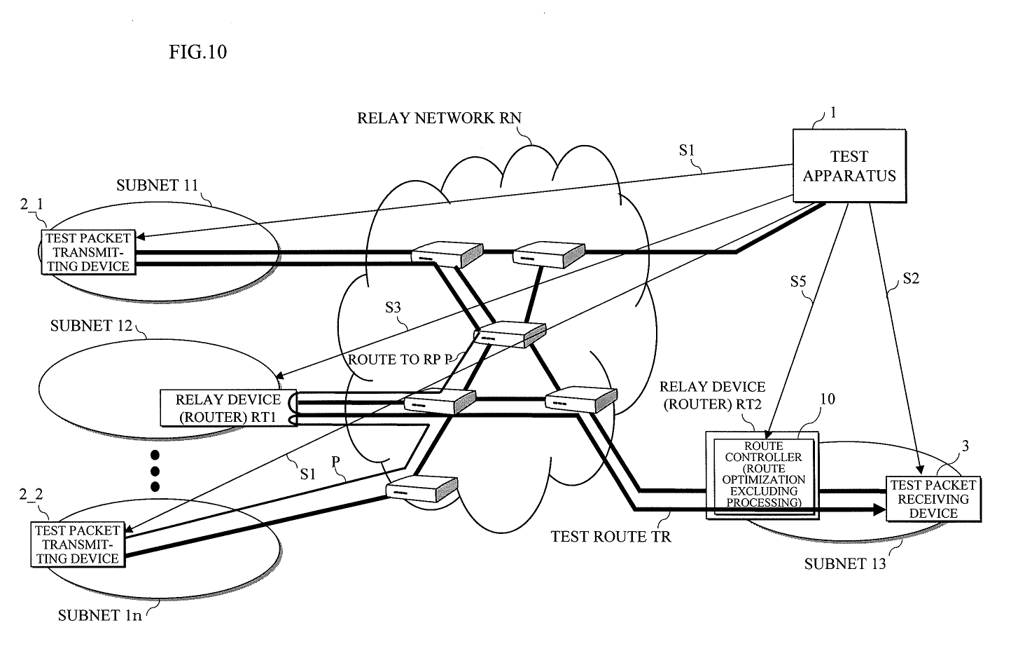

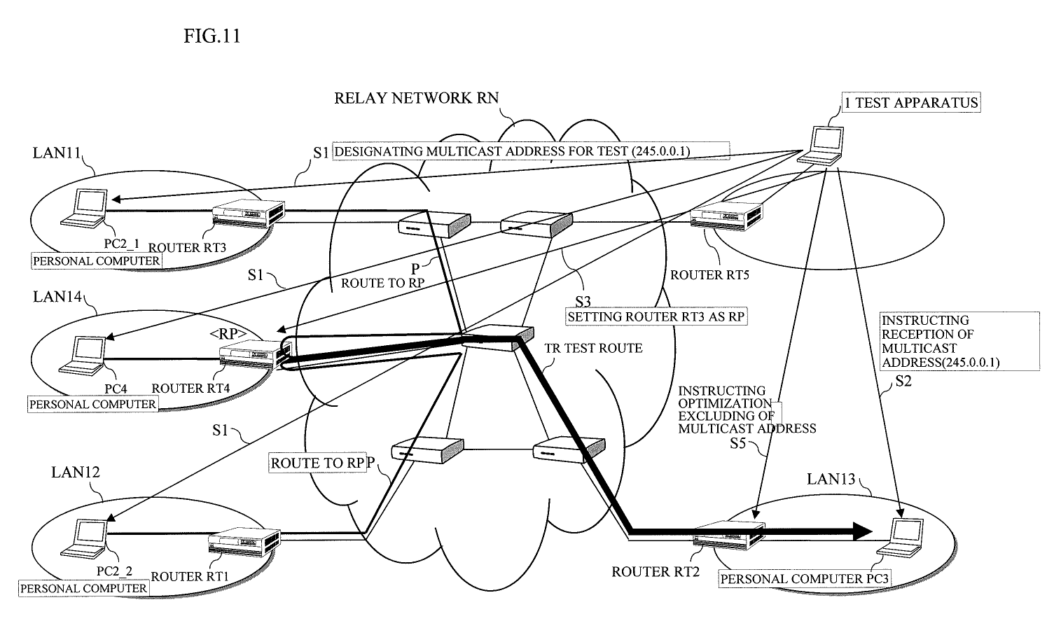

### Embodiment [2]: FIGS. 10 and 11

This embodiment is different from the above embodiment [1] in that as depicted in FIG. 10, a plurality of test packet transmitting devices are used and arranged for a plurality of subnets.

The fundamental operation of this case is the same as the embodiment [1] in the network depicted in FIG. 1, where in the example depicted in FIG. 10 a test packet transmitting device 2_1 is provided in the subnet 11 and a test packet transmitting device 2_2 is provided in another subnet 1n. Also, the test apparatus 1 designates the same multicast address with respect to the test packet transmitting devices 2_1 and 2_2 (step S1), so that those test packet transmitting devices 2_1 and 2_2 transmit the test packet by using the designated multicast address.

Accordingly, even if the traffic quantity of the test packet which each of the test packet transmitting devices 2_1 and 2_2 can transmit is small, the test packets from those test packet transmitting devices are consolidated at the relay device RT1, thereby enabling a large quantity of load to be imposed on the route from the relay device RT1 to the relay device RT2.

FIG. 11 depicts the embodiment of FIG. 10 more specifically. Namely, a personal computer PC2_1 as the test packet transmitting device is arranged in the LAN 11 as a subnet, a personal computer PC2_2 as the test packet transmitting device is arranged in the LAN 12 and a personal computer PC4 as the test packet transmitting device is also arranged in the LAN 14.

When a test operation between the routers RT4-RT2 over the LAN 14 and LAN 13 is performed with the personal computers PC2_1, PC2_2 and PC4, the test apparatus 1 assigns e.g. “245.0.0.1” as the testing multicast address to be notified to the personal computers PC2_1, PC2_2 and PC4 (step S1). The personal computers PC2_1, PC2_2 and PC4 transmit at the same time the test packets by using the multicast address “245.0.0.1”. Also, the test apparatus 1 sets the router RT4 in the LAN 14 to form an RP router of the multicast address “245.0.0.1” (step S3).

According to these settings, the test packets transmitted from the personal computers PC2_1 and PC2_2 in the LAN 11 and LAN 12 pass through the route P and the test packet form the personal computer PC4 passes through LAN 14, whereby all of the test packets from the personal computer PC4 are collected at the router RT4 in the LAN 14 and transferred to the personal computer PC3 from the router RT2 in the LAN 13 through the test route TR.

This enables those test packets to be collected at least at the router RT4 in the LAN 14 which is the bandwidth of the test packets transmittable from individual personal computers and a high load test of the route between the LAN 14 and the LAN 13 to be made.

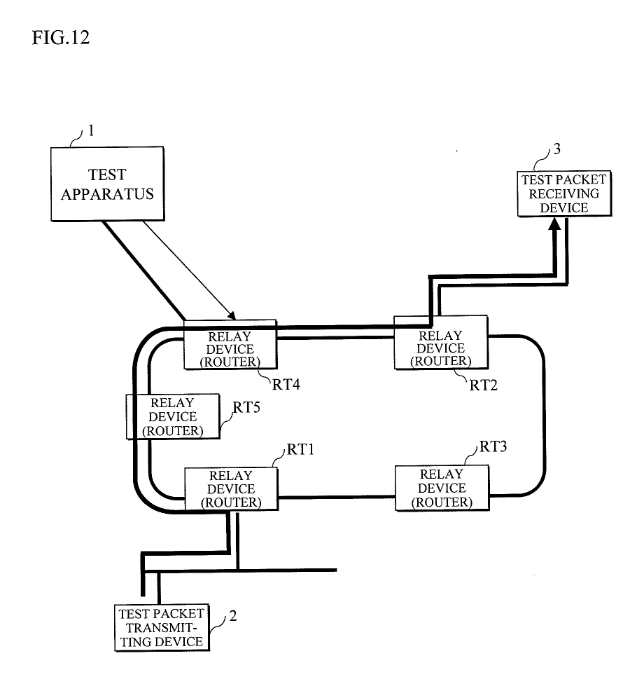

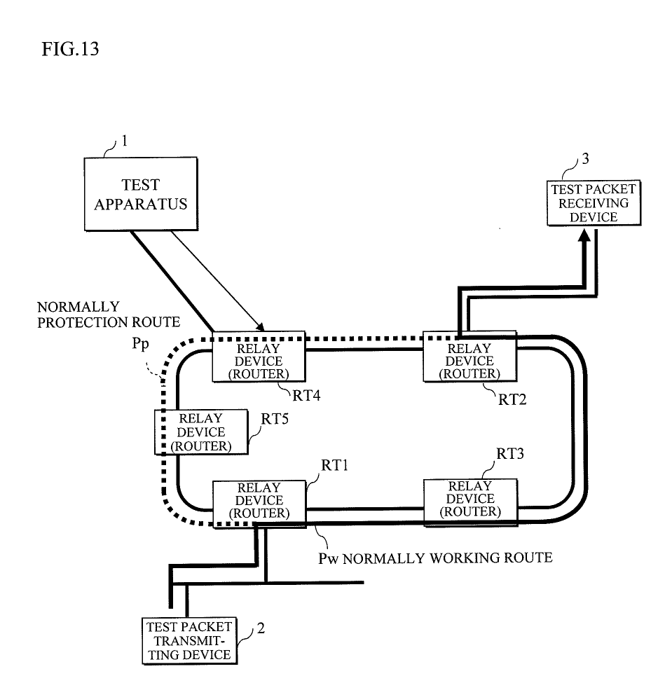

### Applied Example: FIGS. 12 and 13

An applied example (No. 1) depicted in FIG. 12 is different from the above embodiments [1] and [2] in respect of test for a point existing on the way, not at a terminal point on the route which the relay device RT1 desires to measure. In this case, the test apparatus 1 changes the relay device to form the relay device RT1 to the relay device RT4 in the applied example depicted in FIG. 12, enabling a quality/load test to be performed with respect to various routes between arbitrary two points.

An applied example (No. 2) in FIG. 13 depicts a configuration upon measuring the quality of a bypass route P_{P} in a case where there occurs a fault in a route P_{W} at the time of normal operation as depicted in FIG. 12. In this case, any one of the relay devices (e.g. the relay device RT4) in the bypass route P_{P} is made a relay device for multicast relay, whereby only the test packets are transferred to the bypass route while the route at the normal time is being operated, thereby enabling the quality/load test for the bypass route to be made.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network testing method by a test apparatus or a test packet transmitting device comprising:
instructing a test packet receiving device to receive a test packet having a specified multicast address;
instructing a first relay device to relay the test packet having the multicast address; and
instructing a second relay device to perform a route optimization excluding processing;
the test packet receiving device requesting the second relay device to transfer the test packet having the multicast address when the test packet receiving device has received the instruction to receive the test packet.

2. A network testing system comprising:
a test apparatus or a test packet transmitting device;
a test packet receiving device; and
a first and a second relay device;
the test apparatus or the test packet transmitting device instructing the test packet receiving device to receive a test packet having a specified multicast address, instructing the first relay device to relay the test packet having the multicast address, and instructing the second relay device to perform a route optimization excluding processing, in which the test packet receiving device requests the second relay device to transfer the test packet having the multicast address when the test packet receiving device has received the instruction to receive the test packet.

3. The network testing system as claimed in claim 2, wherein the second relay device includes a route controller measuring a reception bandwidth of the test packet of the multicast address when receiving a set condition of a reception bandwidth for the instruction to perform the route optimization excluding processing and enabling the route optimization excluding processing to be performed when the reception bandwidth measured satisfies the set condition.

4. The network testing system as claimed in claim 3, wherein when a test start time is additionally set for the instruction to perform the route optimization excluding processing, the route controller enables the route optimization excluding processing to be performed when the test start time set has come.

5. The network testing system as claimed in claim 2, wherein the second relay device includes a route controller enabling the route optimization excluding processing to be performed if an address of the packet received is found to be the multicast address when the multicast address for the instruction to perform the route optimization excluding processing is received.

6. The network testing system as claimed in claim 2, wherein the test packet transmitting device includes a plurality of test packet transmitting devices.

7. The network testing system as claimed in claim 2, wherein the test packet transmitting device or the test packet receiving device notifies the multicast address to the test apparatus before test start.

8. The network testing system as claimed in claim 1, wherein the first relay device forms an RP (Rendezvous Point) of a PIM-SM (Protocol Independent Multicast-Sparse Mode), in which the instructions to perform the route optimization excluding processing indicate an issuance stop of a Join by the PIM-SM.

9. The network testing system as claimed in claim 2, wherein the test packet transmitting device or the test packet receiving device comprises a router.
